(19) United States
(12) Patent Application Publication
(10) Pub. No.: US 2026/0211285 A1
(43) Pub. Date: Jul. 23, 2026

(54) LIQUID CRYSTAL PANEL

(71) Applicant: Sharp Display Technology Corporation, Kameyama City (JP)

(72) Inventors: Katsuhiro OKADA, Kameyama City (JP); Hiroto AKIYAMA, Kameyama City (JP)

(21) Appl. No.: 19/453,446

(22) Filed: Jan. 20, 2026

(30) Foreign Application Priority Data
Jan. 20, 2025 (JP) 2025-007983

(51) Int. Cl. G02F 1/1339; G02F 1/1337

(52) U.S. Cl. CPC G02F 1/1339; G02F 1/1337; G02F 2201/56

(57) ABSTRACT

A liquid crystal panel includes a first substrate including a first alignment film and including a first main surface including a non-disposition region formed along a connection portion and in which the first alignment film is not disposed and a disposition region in which the first alignment film is disposed, a second substrate including a second main surface, a liquid crystal layer disposed between the first main surface and the second main surface, and a seal disposed between the first main surface and the second main surface, surrounding the liquid crystal layer, and including a first portion disposed along the connection portion and a remaining second portion, at least a part of an interface between the first substrate and the first portion being formed in the non-disposition region, and an entire interface between the first substrate and the second portion being formed in the disposition region.

### CROSS-REFERENCE TO RELATED APPLICATIONS

This application claims the benefit of priority to Japanese Patent Application Number 2025-007983 filed on January 20, 2025. The entire contents of the above-identified application are hereby incorporated by reference.

### BACKGROUND

### TECHNICAL FIELD

The disclosure relates to a liquid crystal panel.

JP 2016-9181 A discloses a liquid crystal display device. In the liquid crystal display device, a liquid crystal layer is disposed between two substrates. A sealing material of a sealing portion bonds and fixes the two substrates together, and seals the liquid crystal layer. A damming member of the sealing portion prevents an alignment film from spreading to a peripheral edge portion. A part of the sealing material overlaps the peripheral edge portion of the alignment film in a thickness direction inside the damming member. Another part of the sealing material does not overlap the peripheral edge portion of the alignment film outside the damming member and is in close contact with a resin layer (paragraphs 0033, 0034, 0051, and 0055).

### SUMMARY

In the liquid crystal display device disclosed in JP 2016-9181 A, the adhesion strength of the sealing material to the substrate in the vicinity of corner portions of the liquid crystal display device is approximately the same as the adhesion strength of the sealing material to the substrate in a portion other than the vicinity of side portions of the liquid crystal display device. Therefore, when the liquid crystal display device falls from a corner portion and stress is concentrated at the corner portion, there is a likelihood that the sealing material will peel off from the substrate in the vicinity of the corner portion.

Furthermore, in the liquid crystal display device disclosed in JP 2016-9181 A, the alignment film is prevented from spreading to the peripheral edge portion. This results in a non-uniform in-plane distribution of chromaticity in the liquid crystal display device.

One aspect of the disclosure has been made in light of this problem. An object of one aspect of the disclosure is to provide a liquid crystal panel having high sealing strength and a uniform in-plane distribution of chromaticity, for example.

A liquid crystal panel according to an aspect of the disclosure is a liquid crystal panel including two sides adjacent to each other and a connection portion connecting the two sides to each other, the liquid crystal panel including: a first substrate including a first alignment film and including a first main surface, the first main surface including a non-disposition region formed along the connection portion and in which the first alignment film is not disposed and a disposition region in which the first alignment film is disposed; a second substrate including a second main surface; a liquid crystal layer disposed between the first main surface and the second main surface; and a seal disposed between the first main surface and the second main surface, surrounding the liquid crystal layer, and including a first portion disposed along the connection portion and a remaining second portion, at least a part of an interface between the first substrate and the first portion being formed in the non-disposition region, and an entire interface between the first substrate and the second portion being formed in the disposition region.

### BRIEF DESCRIPTION OF DRAWINGS

The disclosure will be described with reference to the accompanying drawings, wherein like numbers reference like elements.

FIG. 1 is an exploded cross-sectional view schematically illustrating a liquid crystal display device according to a first embodiment.

FIG. 2 is a plan view schematically illustrating a liquid crystal cell provided in the liquid crystal display device according to the first embodiment.

FIG. 3 is a plan view schematically illustrating a liquid crystal cell provided in a liquid crystal display device according to a first modification example of the first embodiment.

FIG. 4 is a plan view schematically illustrating a liquid crystal cell provided in a liquid crystal display device according to a second modification example of the first embodiment.

FIG. 5 is a plan view schematically illustrating a liquid crystal cell provided in a liquid crystal display device according to a third modification example of the first embodiment.

FIG. 6 is a front view schematically illustrating slits formed in a thin film transistor (TFT) substrate provided in a liquid crystal display device according to a fourth modification example of the first embodiment.

FIG. 7 is a front view schematically illustrating slits formed in a TFT substrate provided in a liquid crystal display device according to a fifth modification example of the first embodiment.

FIG. 8 is a cross-sectional view schematically illustrating a cross section of the liquid crystal cell provided in the liquid crystal display device according to the first embodiment, taken along cutting line VIII-VIII illustrated in FIG. 2.

FIG. 9 is a cross-sectional view schematically illustrating a cross section of the liquid crystal cell provided in the liquid crystal display device according to the first embodiment, taken along cutting line IX-IX illustrated in FIG. 2.

FIG. 10 is a plan view schematically illustrating a liquid crystal cell provided in the liquid crystal display device according to the first embodiment.

FIG. 11 is a plan view schematically illustrating a liquid crystal cell provided in a liquid crystal display device according to a sixth modification example of the first embodiment.

FIG. 12 is a plan view schematically illustrating a liquid crystal cell provided in a liquid crystal display device according to a seventh modification example of the first embodiment.

FIG. 13 is a cross-sectional view schematically illustrating a liquid crystal cell provided in a liquid crystal display device according to a second embodiment.

FIG. 14 is a cross-sectional view schematically illustrating a liquid crystal cell provided in a liquid crystal display device according to a third embodiment.

FIG. 15 is a cross-sectional view schematically illustrating a liquid crystal cell provided in a liquid crystal display device according to a fourth embodiment.

### DESCRIPTION OF EMBODIMENTS

With reference to the drawings, embodiments of the disclosure will be described below. Note that, in the drawings, identical or equivalent elements are given an identical reference sign, and redundant descriptions thereof may be omitted.

### First Embodiment

### Liquid Crystal Display Device

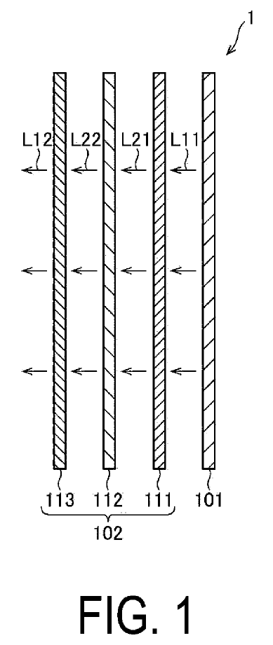

FIG. 1 is an exploded cross-sectional view schematically illustrating a liquid crystal display device according to a first embodiment.

A liquid crystal display device 1 according to the first embodiment illustrated in FIG. 1 displays an image according to an input drive signal.

As illustrated in FIG. 1, the liquid crystal display device 1 includes a backlight 101 and a liquid crystal panel 102.

The backlight 101 emits backlight illumination L11.

The liquid crystal panel 102 modulates the backlight illumination L11 in accordance with the input drive signal to generate image light L12. The image light L12 has an in-plane distribution of intensity according to the drive signal.

The liquid crystal display device 1 displays an image according to the image light L12. Accordingly, the liquid crystal display device 1 displays an image according to the input drive signal.

The liquid crystal panel 102 is an in-plane switching (IPS) liquid crystal panel. The technique described below may be employed in liquid crystal panels of a type other than the IPS type. For example, the technique described below may be employed in liquid crystal panels of a fringe field switching (FFS) type, a vertical alignment (VA) type, a twisted nematic (TN) type, or the like.

As illustrated in FIG. 1, the liquid crystal panel 102 includes a first polarizer 111, a liquid crystal cell 112, and a second polarizer 113.

The first polarizer 111 selectively transmits polarized light L21 having a first polarization direction, which is included in the backlight illumination L11.

The liquid crystal cell 112 modulates the polarized light L21 in accordance with the input drive signal to generate modulated light L22. The modulated light L22 has an in-plane distribution of polarization directions according to the drive signal.

The second polarizer 113 selectively transmits the image light L12 having a second polarization direction, which is included in the modulated light L22.

Thus, the liquid crystal panel 102 emits the image light L12 having an in-plane distribution of intensity according to the input drive signal.

### Planar Shape of Liquid Crystal Cell

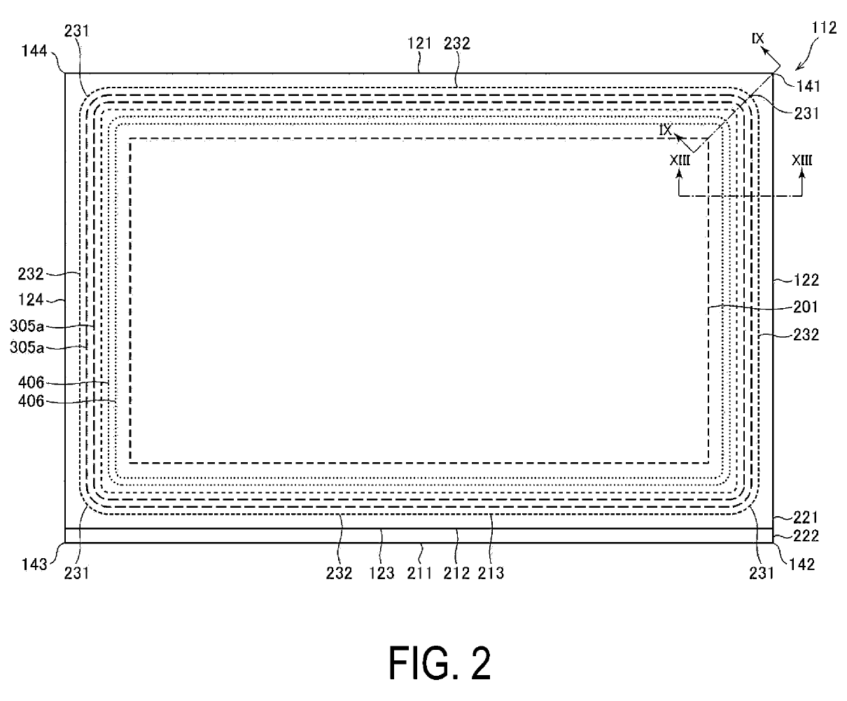

FIG. 2 is a plan view schematically illustrating a liquid crystal cell provided in the liquid crystal display device according to the first embodiment.

As illustrated in FIG. 2, the liquid crystal cell 112 has a rectangular planar shape. The liquid crystal cell 112 has the same planar shape as the planar shape of the liquid crystal panel 102. Therefore, the liquid crystal panel 102 and the liquid crystal cell 112 have sides 121,122,123, and 124. The sides 121, 122, 123, and 124 include first two sides 121 and 122 adjacent to each other, second two sides 122 and 123 adjacent to each other, third two sides 123 and 124 adjacent to each other, and fourth two sides 124 and 121 adjacent to each other.

The liquid crystal panel 102 and the liquid crystal cell 112 have a first corner 141, a second corner 142, a third corner 143, and a fourth corner 144. Each of the first corner 141, the second corner 142, the third corner 143, and the fourth corner 144 has an angular planar shape and forms an angle of 90°. The first corner 141, the second corner 142, the third corner 143, and the fourth corner 144 serve as connection portions that respectively connect the first two sides 121 and 122, the second two sides 122 and 123, the third two sides 123 and 124, and the fourth two sides 124 and 121 to each other.

When the liquid crystal panel 102 falls from one of the corners included in the first corner 141, the second corner 142, the third corner 143, and the fourth corner 144, stress is concentrated at the one corner. Therefore, when the liquid crystal panel 102 falls from the one corner, the structure of the liquid crystal panel 102 near the one corner is likely to be damaged.

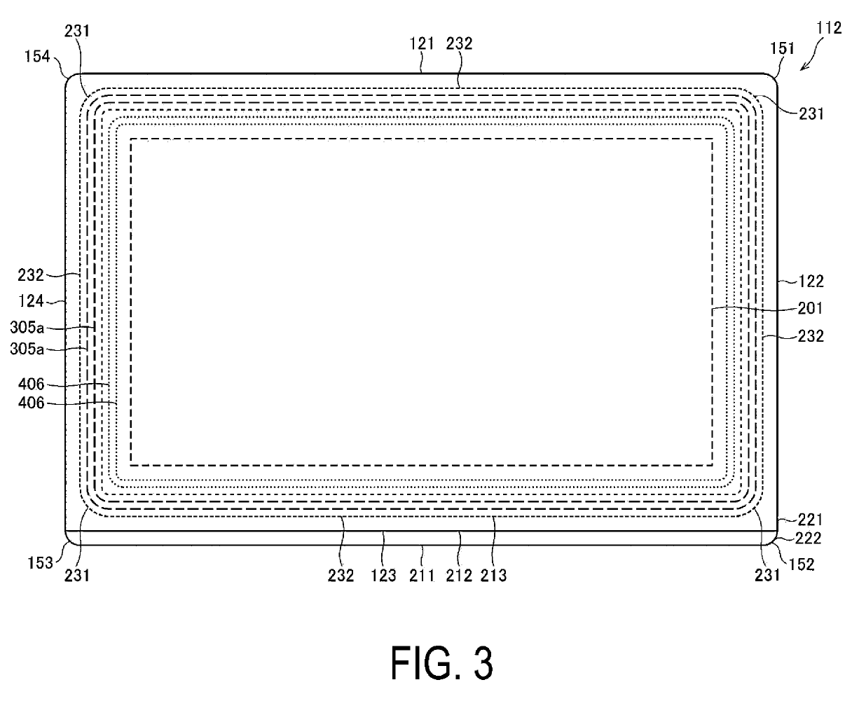

FIG. 3 is a plan view schematically illustrating a liquid crystal cell provided in a liquid crystal display device according to a first modification example of the first embodiment.

In the first modification example of the first embodiment, as illustrated in FIG. 3, the liquid crystal panel 102 and the liquid crystal cell 112 have a first R-chamfered portion 151, a second R-chamfered portion 152, a third R-chamfered portion 153, and a fourth R-chamfered portion 154. Each of the first R-chamfered portion 151, the second R-chamfered portion 152, the third R-chamfered portion 153, and the fourth R-chamfered portion 154 has a planar shape obtained by rounding a corner into an arc shape. The first R-chamfered portion 151, the second R-chamfered portion 152, the third R-chamfered portion 153, and the fourth R-chamfered portion 154 serve as connection portions that respectively connect the first two sides 121 and 122, the second two sides 122 and 123, the third two sides 123 and 124, and the fourth two sides 124 and 121 to each other.

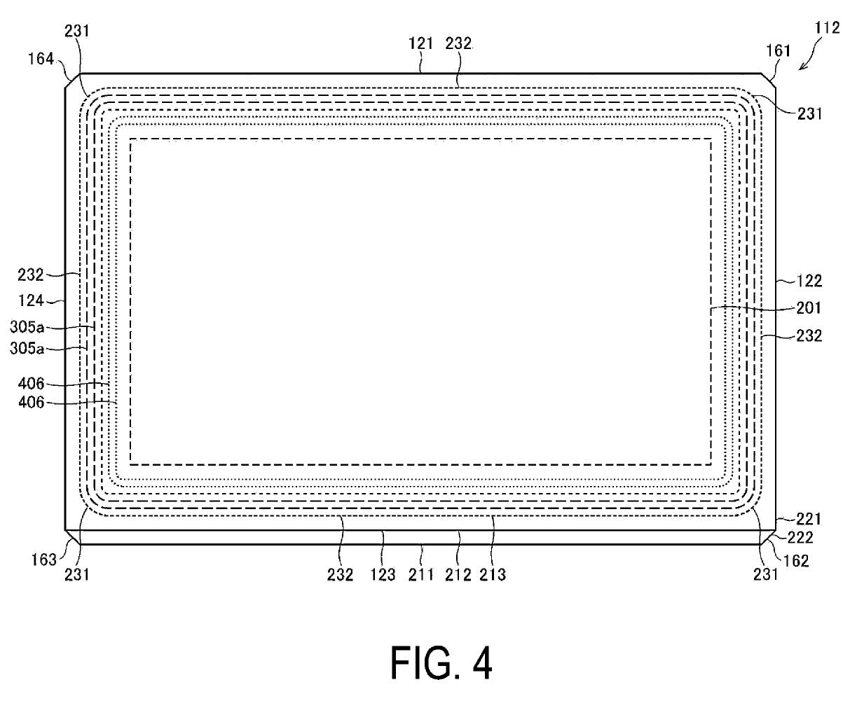

FIG. 4 is a plan view schematically illustrating a liquid crystal cell provided in a liquid crystal display device according to a second modification example of the first embodiment.

In the second modification example of the first embodiment, as illustrated in FIG. 4, the liquid crystal panel 102 and the liquid crystal cell 112 have a first C-chamfered portion 161, a second C-chamfered portion 162, a third C-chamfered portion 163, and a fourth C-chamfered portion 164. Each of the first C-chamfered portion 161, the second C-chamfered portion 162, the third C-chamfered portion 163, and the fourth C-chamfered portion 164 has a planar shape obtained by trimming a corner along a straight line. The first C-chamfered portion 161, the second C-chamfered portion 162, the third C-chamfered portion 163, and the fourth C-chamfered portion 164 serve as connection portions that respectively connect the first two sides 121 and 122, the second two sides 122 and 123, the third two sides 123 and 124, and the fourth two sides 124 and 121 to each other.

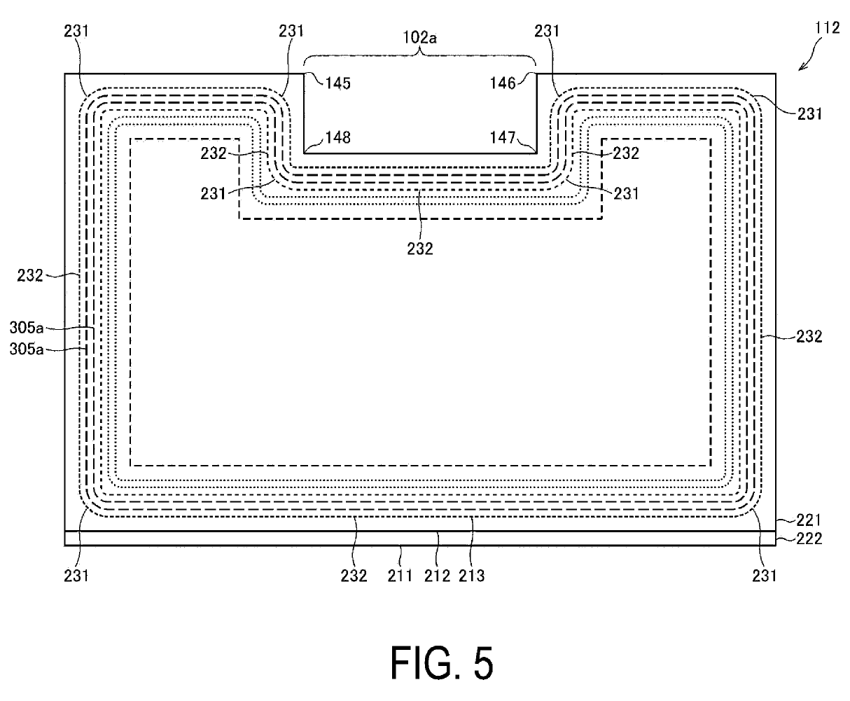

FIG. 5 is a plan view schematically illustrating a liquid crystal cell provided in a liquid crystal display device according to a third modification example of the first embodiment.

In the third modification example of the first embodiment, as illustrated in FIG. 5, a notch 102a is formed in the liquid crystal panel 102. A camera or the like is disposed in the notch 102a. The notch 102a has a rectangular planar shape or the like. The liquid crystal panel 102 and the liquid crystal cell 112 have a fifth corner 145, a sixth corner 146, a seventh corner 147, and an eighth corner 148 formed by the notch 102a. Each of the fifth corner 145, the sixth corner 146, the seventh corner 147, and the eighth corner 148 also serves as a connection portion that connects two sides to each other.

### Planar Shapes of Thin Film Transistor (TFT) Substrate, Color Filter (CF) Substrate, Seal, Slit, and Pattern

As illustrated in FIG. 2, the liquid crystal cell 112 has an active region 201. The liquid crystal display device 1 displays an image according to the light transmitted through the active region 201.

As illustrated in FIG. 2, the liquid crystal panel 102 includes a TFT substrate 211, a CF substrate 212, and a seal 213. Two slits 305a are formed in the TFT substrate 211. The CF substrate 212 includes two patterns 406.

The TFT substrate 211 has a rectangular planar shape. The TFT substrate 211 has a planar shape larger than the planar shape of the CF substrate 212. The TFT substrate 211 includes an overlapping portion 221 and a non-overlapping portion 222. The overlapping portion 221 has the same planar shape as the CF substrate 212 and overlaps the CF substrate 212. The non-overlapping portion 222 does not overlap the CF substrate 212. The TFT substrate 211 is an example of an array substrate. Therefore, the TFT substrate 211 may be replaced with an array substrate other than the TFT substrate 211.

The CF substrate 212 has a rectangular planar shape. The CF substrate 212 is an example of a counter substrate. Therefore, the CF substrate 212 may be replaced with a counter substrate other than the CF substrate 212.

The seal 213 suppresses spreading of a liquid crystal layer described later. The two slits 305a and the two patterns 406 prevent an alignment film (described later) from spreading in the vicinity of the first corner 141, the second corner 142, the third corner 143, and the fourth corner 144.

The seal 213, the two slits 305a, and the two patterns 406 have a ring-shaped planar shape. The seal 213 is disposed along the outer periphery of the overlapping portion 221 of the TFT substrate 211 and the outer periphery of the CF substrate 212. The two slits 305a are formed in a region where the seal 213 is disposed. One of the two slits 305a is disposed more inward than the other of the two slits 305a. The two patterns 406 are disposed along the inner periphery of the region where the seal 213 is disposed. One of the two patterns 406 is disposed more inward than the other of the two patterns 406. The seal 213, the two slits 305a and the two patterns 406 surround the active region 201. Each of the two slits 305a extends along a straight line in a region other than the vicinity of the first corner 141, the second corner 142, the third corner 143, and the fourth corner 144.

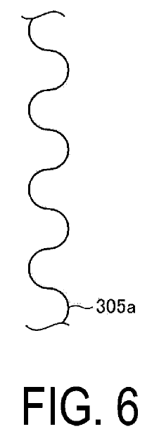

FIG. 6 is a front view schematically illustrating slits formed in a TFT substrate provided in a liquid crystal display device according to a fourth modification example of the first embodiment.

In the fourth modification example of the first embodiment, as illustrated in FIG. 6, the slit 305a extends along a wavy line in a region other than the vicinity of the first corner 141, the second corner 142, the third corner 143, and the fourth corner 144.

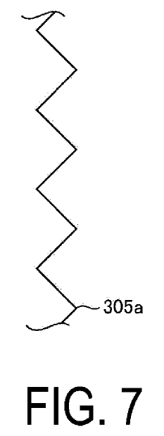

FIG. 7 is a front view schematically illustrating slits formed in a TFT substrate provided in a liquid crystal display device according to a fifth modification example of the first embodiment.

In the fifth modification example of the first embodiment, as illustrated in FIG. 7, the slit 305a extends along a zigzag line in a region other than the vicinity of the first corner 141, the second corner 142, the third corner 143, and the fourth corner 144.

When the slit 305a extends along a curved line such as a wavy line or a bent line such as a zigzag line, the length of the slit 305a can be increased.

As illustrated in FIG. 2, the seal 213 includes four first portions 231 and four second portions 232.

The four first portions 231 are portions that are disposed along the first corner 141, the second corner 142, the third corner 143, and the fourth corner 144, respectively. The four second portions 232 are the remaining portions disposed along the sides 121, 122, 123, and 124, respectively. As described above, when the liquid crystal panel 102 falls from one of the corners included in the first corner 141, the second corner 142, the third corner 143, and the fourth corner 144, the structure of the liquid crystal panel 102 near the one corner is likely to be damaged. Therefore, when the liquid crystal panel 102 falls from the one corner, the first portion 231 disposed along the one corner is likely to peel off from the TFT substrate 211 or the CF substrate 212. Therefore, four notches are formed in alignment films of the TFT substrate 211 and the CF substrate 212 to prevent the four first portions 231 from peeling off from the TFT substrate 211 and the CF substrate 212.

The first embodiment discloses an example in which notches are formed in the alignment films of both of the two substrates of the liquid crystal panel 102. A first substrate of the two substrates is one of the TFT substrate 211 and the CF substrate 212. The second substrate of the two substrates is the other substrate of the TFT substrate 211 and the CF substrate 212.

### Cross-sectional Structure of Liquid Crystal Panel

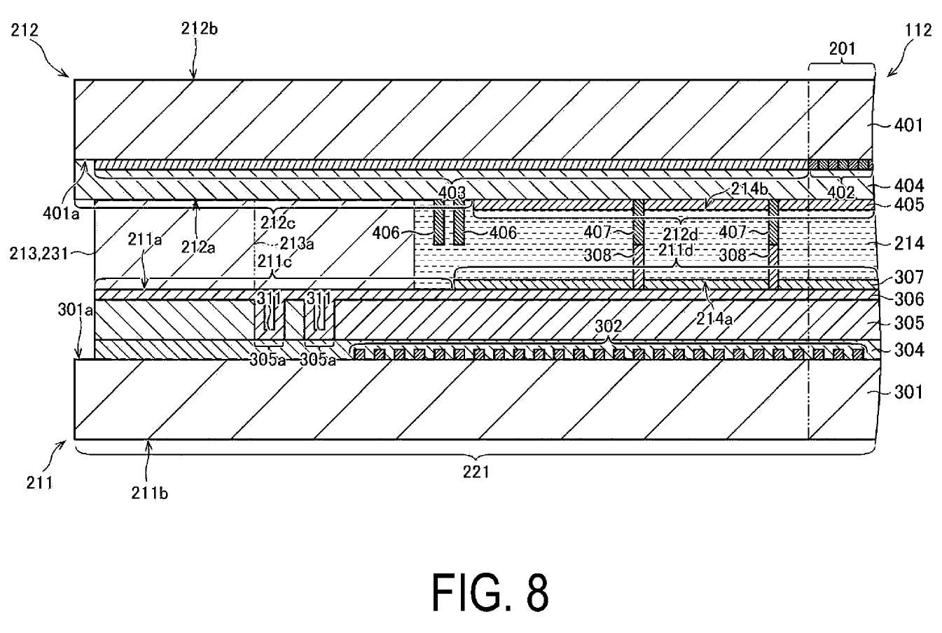

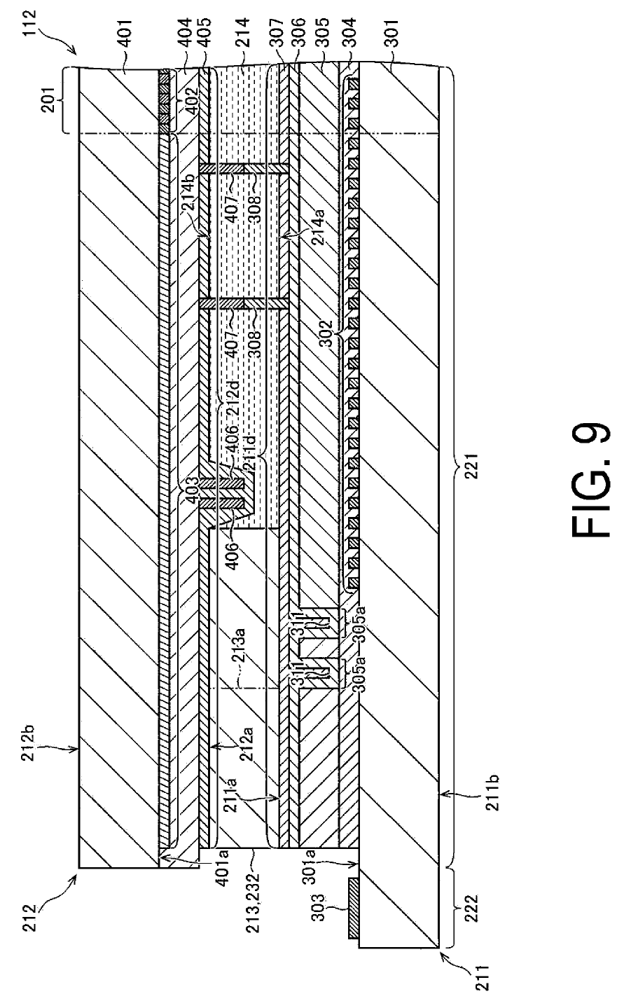

FIG. 8 is a cross-sectional view schematically illustrating a cross section of the liquid crystal cell provided in the liquid crystal display device according to the first embodiment, taken along cutting line VIII-VIII illustrated in FIG. 2. FIG. 9 is a cross-sectional view schematically illustrating a cross section of the liquid crystal cell provided in the liquid crystal display device according to the first embodiment, taken along cutting line IX-IX illustrated in FIG. 2.

As illustrated in FIGS. 8 and 9, the liquid crystal cell 112 includes a TFT substrate 211, a CF substrate 212, a seal 213, and a liquid crystal layer 214.

The TFT substrate 211 has main surfaces 211a and 211b. The main surfaces 211a and 211b are opposite each other. The CF substrate 212 has main surfaces 212a and 212b. The main surfaces 212a and 212b are opposite each other. The main surface 211a of the TFT substrate 211 and the main surface 212a of the CF substrate 212 face each other with a gap therebetween.

The polarized light L21 is incident on the main surface 211b of the TFT substrate 211. The TFT substrate 211 transmits the incident polarized light L21. The main surface 211a of the TFT substrate 211 emits polarized light that has been transmitted through the TFT substrate 211. The TFT substrate 211 aligns liquid crystal molecules contained in the liquid crystal layer 214 in an initial alignment direction, and in each pixel of the liquid crystal panel 102, an electrical field corresponding to the input drive signal is applied to the liquid crystal layer 214, causing the liquid crystal molecules to rotate from the initial alignment direction by a rotation angle corresponding to the drive signal.

The seal 213 is disposed between the main surface 211a of the TFT substrate 211 and the main surface 212a of the CF substrate 212. The seal 213 is disposed along the outer periphery of the region where the liquid crystal layer 214 is disposed. The seal 213 surrounds the liquid crystal layer 214. The seal 213 is in close contact with the main surface 211a of the TFT substrate 211 and the main surface 212a of the CF substrate 212. Accordingly, the seal 213 is connected to the TFT substrate 211 and the CF substrate 212, and the TFT substrate 211 and the CF substrate 212 are connected to each other. The gap between the TFT substrate 211 and the seal 213 is sealed airtight and liquid-tight. The gap between the CF substrate 212 and the seal 213 is also sealed airtight and liquid-tight. Thus, the liquid crystal layer 214 is sealed by the seal 213. This can prevent the liquid crystal layer 214 from leaking from the inside of the seal 213 to the outside of the seal 213. Furthermore, moisture and the like can be prevented from entering from the outside of the seal 213 to the inside of the seal 213.

The liquid crystal layer 214 is disposed between the main surface 211a of the TFT substrate 211 and the main surface 212a of the CF substrate 212. The liquid crystal layer 214 is disposed in a region including the active region 201. The liquid crystal layer 214 has main surfaces 214a and 214b. The main surfaces 214a and 214b are opposite each other. The main surfaces 214a and 214b of the liquid crystal layer 214 are in contact with the main surface 211a of the TFT substrate 211 and the main surface 212a of the CF substrate 212, respectively. The polarized light emitted from the main surface 211a of the TFT substrate 211 is incident on the main surface 214a of the liquid crystal layer 214. The liquid crystal layer 214 transmits incident polarized light. The main surface 214b of the liquid crystal layer 214 emits light that has been transmitted through the liquid crystal layer 214. The liquid crystal layer 214 rotates the polarization direction of the light emitted from each pixel of the liquid crystal panel 102 by a rotation angle corresponding to the rotation angle of the liquid crystal molecules contained in the liquid crystal layer 214.

The light emitted from the main surface 214b of the liquid crystal layer 214 is incident on the main surface 212a of the CF substrate 212. The CF substrate 212 transmits a color component corresponding to the color of each pixel included in the incident light in each pixel of the liquid crystal panel 102. The main surface 212b of the CF substrate 212 emits color components that have been transmitted through the CF substrate 212.

### TFT Substrate

As illustrated in FIGS. 8 and 9, the TFT substrate 211 includes a glass substrate 301, a plurality of wiring lines 302, a plurality of terminals 303, a layered film 304, an organic insulating film 305, a passivation film 306, an alignment film 307, and a plurality of bumps 308. The TFT substrate 211 includes a plurality of TFTs, a plurality of pixel electrodes, and a plurality of common electrodes (not illustrated).

The glass substrate 301 supports the plurality of wiring lines 302, the plurality of terminals 303, the layered film 304, the organic insulating film 305, the passivation film 306, the alignment film 307, and the plurality of bumps 308. The glass substrate 301 is made of glass. The glass substrate 301 may be replaced with a substrate made of a material other than glass. The glass substrate 301 has a main surface 301a.

The glass substrate 301, the plurality of wiring lines 302, the plurality of terminals 303, the layered film 304, the organic insulating film 305, the passivation film 306, the alignment film 307, and the plurality of bumps 308 are disposed on the main surface 301a of the glass substrate 301. The glass substrate 301, the plurality of wiring lines 302, the layered film 304, the organic insulating film 305, the passivation film 306, the alignment film 307, and the plurality of bumps 308 are provided in the overlapping portion 221. The plurality of terminals 303 are provided in the non-overlapping portion 222. The layered film 304, the organic insulating film 305, the passivation film 306, and the alignment film 307 do not reach the plurality of terminals 303.

The plurality of wiring lines 302 are disposed directly on the main surface 301a of the glass substrate 301. The plurality of wiring lines 302 are disposed in a region inside the region where the seal 213 is disposed and in a region occupying about one-third of the inner periphery of the region where the seal 213 is disposed. The plurality of wiring lines 302 include a plurality of gate wiring lines and a plurality of source wiring lines. The plurality of wiring lines 302 are made of aluminum (Al), an Al alloy, or the like. The plurality of wiring lines 302 transmit drive signals input to the plurality of terminals 303 from the plurality of terminals 303 to the plurality of TFTs.

The plurality of terminals 303 are disposed directly on the main surface 301a of the glass substrate 301. The plurality of terminals 303 are made of Al, an Al alloy, or the like. A drive signal is input to the plurality of terminals 303.

The layered film 304 is disposed on the main surface 301a of the glass substrate 301 to overlap the plurality of wiring lines 302. The layered film 304 includes a gate insulating film and a passivation film. The gate insulating film and the passivation film are layered. The gate insulating film is made of silicon nitride (SiNₓ) or the like. The passivation film is made of SiNₓ or the like. The gate insulating film separates the plurality of wiring lines 302 disposed below the gate insulating film and the elements disposed above the gate insulating film from each other, and electrically insulates the plurality of wiring lines 302 and the elements from each other. The passivation film protects the plurality of TFTs disposed below the passivation film.

The organic insulating film 305 is disposed on the layered film 304. The organic insulating film 305 provides a flat surface on which the passivation film 306 is formed. The organic insulating film 305 is made of an acrylic resin or the like. Two slits 305a are formed in the organic insulating film 305. Each of the two slits 305a penetrates the organic insulating film 305 in the thickness direction of the organic insulating film 305. The number of slits 305a formed in the organic insulating film 305 may be one or three or more.

The passivation film 306 is disposed on the layered film 304 to overlap the organic insulating film 305. The passivation film 306 is made of SiNₓ or the like. The passivation film 306 protects the plurality of pixel electrodes and the plurality of common electrodes disposed below the passivation film 306. The passivation film 306 also enters each of the two slits 305a in the organic insulating film 305, but does not completely fill each of the two slits 305a. Therefore, two grooves 311 are formed in the layered film including the organic insulating film 305 and the passivation film 306. The number of grooves 311 formed in the layered film may be one or three or more. Each of the two grooves 311 has a ring-shaped planar shape. Two grooves 311 are formed in the region where the seal 213 is disposed. Therefore, the seal 213 enters the two grooves 311. When the slit 305a extends along a curved line such as a wavy line as illustrated in FIG. 6, or when the slit 305a extends along a bent line such as a zigzag line as illustrated in FIG. 7, the length of the slit 305a and the groove 311 can be increased. This makes it possible to increase the area of the interface between the seal 213 and the TFT substrate 211. This can increase the adhesion of the seal 213 to the TFT substrate 211.

The alignment film 307 is disposed on the passivation film 306. The alignment film 307 is made of polyimide or the like. The alignment film 307 is in contact with the liquid crystal layer 214 and aligns the liquid crystal molecules contained in the liquid crystal layer 214 in the initial alignment direction. The alignment film 307 is not disposed in four non-disposition regions 211c along the first corner 141, the second corner 142, the third corner 143, and the fourth corner 144, respectively, but is disposed in a remaining disposition region 211d along the sides 121, 122, 123, and 124. Therefore, the main surface 211a of the TFT substrate 211 has four non-disposition regions 211c formed along the first corner 141, the second corner 142, the third corner 143, and the fourth corner 144, respectively, and in which the alignment film 307 is not disposed, and a disposition region 211d formed along the sides 121, 122, 123, and 124, and in which the alignment film 307 is disposed. The four non-disposition regions 211c are the surface of the passivation film 306. The disposition region 211d is the surface of the alignment film 307. The disposition region 211d extends to the outer periphery of the main surface 211a, excluding the vicinity of the first corner 141, the second corner 142, the third corner 143, and the fourth corner 144. This makes it possible to prevent the outer peripheral portion of the alignment film 307, which may have uneven thickness, from approaching the active region 201 of the liquid crystal panel 102. Accordingly, it is possible to maintain a uniform in-plane distribution of chromaticity of the liquid crystal display device 1.

The alignment film 307 is formed by printing. When the alignment film 307 is formed by printing, a fluid of an alignment film material is applied using a plate to form a fluid film, the formed fluid film is dried to form a dry film, and the formed dry film is subjected to a rubbing treatment to form the alignment film 307. The pattern of the plate used is designed such that the alignment film 307 is not formed in the four non-disposition regions 211c, and the alignment film 307 is formed in the disposition region 211d.

The entire first portion 231 is disposed on the non-disposition region 211c of the TFT substrate 211. Therefore, the entire interface between the first portion 231 and the TFT substrate 211 is formed in the non-disposition region 211c. Therefore, the first portion 231 is not in contact with the alignment film 307 but is in direct contact with the passivation film 306 and is connected to the passivation film 306.

The entire second portion 232 is disposed on the disposition region 211d of the TFT substrate 211. Therefore, the entire interface between the second portion 232 and the TFT substrate 211 is formed in the disposition region 211d. Therefore, the second portion 232 is not in contact with the passivation film 306 but is in direct contact with the alignment film 307 and is connected to the alignment film 307.

The connection strength of the seal 213 to the passivation film 306 is stronger than the connection strength of the seal 213 to the alignment film 307. Therefore, by connecting the entire first portion 231, which relatively easily peels off from the TFT substrate 211, to the passivation film 306, it is possible to prevent the first portion 231 from peeling off from the TFT substrate 211. This can increase the sealing strength of the seal 213. Furthermore, by connecting the entire second portion 232, which is relatively unlikely to peel off from the TFT substrate 211, to the alignment film 307, it is possible to extend the alignment film 307 to the outer periphery of the main surface 211a of the TFT substrate 211 while preventing the sealing strength of the seal 213 from decreasing.

The slit 305a is formed along a seal center position 213a, which is the center of the seal 213 in a width direction. The layered film 304, the organic insulating film 305, and the passivation film 306 do not necessarily need to be formed in the region outside the position where the slit 305a is formed.

The grooves 311 are formed in the surface of the passivation film 306 onto which a fluid of the alignment film material is applied to form the alignment film 307. The pattern of the plate used when the alignment film 307 is formed by printing is designed such that the fluid does not exceed the groove 311 under the first portion 231, and such that the fluid exceeds the groove 311 under the second portion 232.

The plurality of bumps 308 are disposed on the passivation film 306. Each of the plurality of bumps 308 penetrates the alignment film 307 and protrudes toward the CF substrate 212. Each of the plurality of bumps 308 has a dot-shaped planar shape.

When the TFT substrate 211 is the first substrate of the two substrates of the liquid crystal panel 102, the main surface 211a, the non-disposition region 211c, and the disposition region 211d of the TFT substrate 211 are the first main surface, the first non-disposition region, and the first disposition region of the first substrate, respectively, and the alignment film 307 is the first alignment film of the first substrate. When the TFT substrate 211 is the second substrate of the two substrates of the liquid crystal panel 102, the main surface 211a, the non-disposition region 211c, and the disposition region 211d of the TFT substrate 211 are the second main surface, the second non-disposition region, and the second disposition region of the second substrate, respectively, and the alignment film 307 is the second alignment film of the second substrate.

When the liquid crystal panel 102 has the first R-chamfered portion 151, the second R-chamfered portion 152, the third R-chamfered portion 153, and the fourth R-chamfered portion 154, the four non-disposition regions 211c of the TFT substrate 211 are formed along the first R-chamfered portion 151, the second R-chamfered portion 152, the third R-chamfered portion 153, and the fourth R-chamfered portion 154, respectively. When the liquid crystal panel 102 has the first C-chamfered portion 161, the second C-chamfered portion 162, the third C-chamfered portion 163, and the fourth C-chamfered portion 164, the four non-disposition regions 211c of the TFT substrate 211 are formed along the first C-chamfered portion 161, the second C-chamfered portion 162, the third C-chamfered portion 163, and the fourth C-chamfered portion 164, respectively. When the liquid crystal panel 102 has the first C-chamfered portion 161, the second C-chamfered portion 162, the third C-chamfered portion 163, and the fourth C-chamfered portion 164, the non-disposition regions 211c of the TFT substrate 211 may be formed only in the vicinity of the intersections of the C-chamfered portions and the sides. When the notch 102a is formed in the liquid crystal panel 102, the main surface 211a of the TFT substrate 211 also has four non-disposition regions formed along the fifth corner 145, the sixth corner 146, the seventh corner 147, and the eighth corner 148 formed by the notch 102a.

### CF Substrate

As illustrated in FIGS. 8 and 9, the CF substrate 212 includes a glass substrate 401, a plurality of color filters 402, a black matrix 403, an overcoat 404, an alignment film 405, two patterns 406, and a plurality of photo spacers 407.

The glass substrate 401 supports the plurality of color filters 402, the black matrix 403, the overcoat 404, the alignment film 405, the two patterns 406, and the plurality of photo spacers 407. The glass substrate 401 is made of glass. The glass substrate 401 may be replaced with a substrate made of a material other than glass. The glass substrate 401 has a main surface 401a.

The plurality of color filters 402, the black matrix 403, the overcoat 404, the alignment film 405, the two patterns 406, and the plurality of photo spacers 407 are disposed on the main surface 401a of the glass substrate 401.

The plurality of color filters 402 are disposed directly on the main surface 401a of the glass substrate 401. The plurality of color filters 402 are disposed in the active region 201. The plurality of color filters 402 are provided in the plurality of pixels of the liquid crystal panel 102, respectively. The plurality of color filters 402 include a plurality of red color filters, a plurality of green color filters, and a plurality of blue color filters. The plurality of red color filters, the plurality of green color filters, and the plurality of blue color filters selectively transmit red light, green light, and blue light, respectively.

The black matrix 403 is disposed directly on the main surface 401a of the glass substrate 401. The black matrix 403 is disposed in a region outside the active region 201. The black matrix 403 prevents light from passing through. The black matrix 403 may be disposed between adjacent color filters 402.

The overcoat 404 is disposed on the main surface 401a of the glass substrate 401 to overlap the plurality of color filters 402 and the black matrix 403. The overcoat 404 prevents components contained in the plurality of color filters 402 and the black matrix 403 from leaking into the liquid crystal layer 214, and provides a flat surface on which the alignment film 405 is formed. The overcoat 404 is made of an organic material.

The alignment film 405 is disposed on the overcoat 404. The alignment film 405 is made of polyimide or the like. The alignment film 405 is in contact with the liquid crystal layer 214 and aligns the liquid crystal molecules contained in the liquid crystal layer 214 in the initial alignment direction. The alignment film 405 is not disposed in four non-disposition regions 212c along the first corner 141, the second corner 142, the third corner 143, and the fourth corner 144, respectively, but is disposed in a remaining disposition region 212d along the sides 121, 122, 123, and 124. Therefore, the main surface 212a of the CF substrate 212 has four non-disposition regions 212c formed along the first corner 141, the second corner 142, the third corner 143, and the fourth corner 144, respectively, and in which the alignment film 405 is not disposed, and a disposition region 212d formed along the sides 121, 122, 123, and 124, and in which the alignment film 405 is disposed. The four non-disposition regions 212c are the surface of the overcoat 404. The disposition region 212d is the surface of the alignment film 405. The disposition region 212d extends to the outer periphery of the main surface 212a, excluding the vicinity of the first corner 141, the second corner 142, the third corner 143, and the fourth corner 144. This makes it possible to prevent the outer peripheral portion of the alignment film 405, which may have uneven thickness, from approaching the active region 201 of the liquid crystal panel 102. Accordingly, it is possible to maintain a uniform in-plane distribution of chromaticity of the liquid crystal display device 1.

The alignment film 405 is formed by an ink-jet method. When the alignment film 405 is formed by the ink-jet method, a fluid of the alignment film material is applied to form a fluid film, the formed fluid film is dried to form a dry film, and the formed dry film is subjected to a rubbing treatment to form the alignment film 405. The shape and conditions of the application of the fluid are adjusted such that the alignment film 405 is not formed in the four non-disposition regions 212c, and the alignment film 405 is formed in the disposition region 212d.

The entire first portion 231 is disposed on the four non-disposition regions 212c of the CF substrate 212. Therefore, the entire interface between the first portion 231 and the CF substrate 212 is formed in the four non-disposition regions 212c. Therefore, the first portion 231 is not in contact with the alignment film 405 but is in direct contact with the overcoat 404 and is connected to the overcoat 404.

The entire second portion 232 is disposed on the disposition region 212d of the CF substrate 212. Therefore, the entire interface between the second portion 232 and the CF substrate 212 is formed in the disposition region 212d. Therefore, the second portion 232 is not in contact with the overcoat 404 but is in direct contact with the alignment film 405 and is connected to the alignment film 405.

The connection strength of the seal 213 to the overcoat 404 is stronger than the connection strength of the seal 213 to the alignment film 405. Therefore, by connecting the entire first portion 231, which relatively easily peels off from the CF substrate 212, to the overcoat 404, it is possible to prevent the first portion 231 from peeling off from the CF substrate 212, and to increase the sealing strength of the seal 213. Furthermore, by connecting the entire second portion 232, which is relatively unlikely to peel off from the CF substrate 212, to the alignment film 405, it is possible to extend the alignment film 405 to the outer periphery of the main surface 212a of the CF substrate 212 while preventing the sealing strength of the seal 213 from decreasing.

Two patterns 406 are disposed on the overcoat 404. One of the two patterns 406 is disposed more inward than the other of the two patterns 406. The pattern 406 protrudes from the main surface 212a of the CF substrate 212 but does not reach the TFT substrate 211. The pattern 406 is made of the same material as the material that constitutes the plurality of photo spacers 407, and is formed simultaneously with the plurality of photo spacers 407.

The two patterns 406 protrude from the surface of the overcoat 404 onto which a fluid of the alignment film material is applied to form the alignment film 405. When the alignment film 405 is formed by the ink-jet method, the shape and conditions of the application of the fluid are adjusted such that the fluid does not exceed the pattern 406 under the first portion 231, and such that the fluid exceeds the pattern 406 under the second portion 232.

The plurality of photo spacers 407 are disposed on the overcoat 404. Each of the plurality of photo spacers 407 penetrates the alignment film 405 and protrudes toward the TFT substrate 211. Each of the plurality of photo spacers 407 has a dot shape. The tips of the plurality of photo spacers 407 on the CF substrate 212 abut against the tips of the bumps 308 on the TFT substrate 211. Accordingly, the plurality of photo spacers 407 and the bumps 308 are disposed in a region inside the region where the seal 213 is disposed, and form columnar spacers that maintain the interval between the main surface 211a of the TFT substrate 211 and the main surface 211b of the CF substrate 212. By abutting the plurality of photo spacers 407 on the CF substrate 212 and the bumps 308 on the TFT substrate 211 against each other to form columnar spacers, it is possible to prevent the plurality of photo spacers 407 from coming into direct contact with the alignment film 307 and damaging the alignment film 307.

When the CF substrate 212 is the first substrate of the two substrates of the liquid crystal panel 102, the main surface 212a, the non-disposition region 212c, and the disposition region 212d of the CF substrate 212 are the first main surface, the first non-disposition region, and the first disposition region of the first substrate, respectively, and the alignment film 405 is the first alignment film of the first substrate. When the CF substrate 212 is the second substrate of the two substrates of the liquid crystal panel 102, the main surface 212a, the non-disposition region 212c, and the disposition region 212d of the CF substrate 212 are the second main surface, the second non-disposition region, and the second disposition region of the second substrate, respectively, and the alignment film 405 is the second alignment film of the second substrate.

When the liquid crystal panel 102 has the first R-chamfered portion 151, the second R-chamfered portion 152, the third R-chamfered portion 153, and the fourth R-chamfered portion 154, the four non-disposition regions 212c of the CF substrate 212 are formed along the first R-chamfered portion 151, the second R-chamfered portion 152, the third R-chamfered portion 153, and the fourth R-chamfered portion 154, respectively. When the liquid crystal panel 102 has the first C-chamfered portion 161, the second C-chamfered portion 162, the third C-chamfered portion 163, and the fourth C-chamfered portion 164, the four non-disposition regions 212c of the CF substrate 212 are formed along the first C-chamfered portion 161, the second C-chamfered portion 162, the third C-chamfered portion 163, and the fourth C-chamfered portion 164, respectively. When the liquid crystal panel 102 has the first C-chamfered portion 161, the second C-chamfered portion 162, the third C-chamfered portion 163, and the fourth C-chamfered portion 164, the non-disposition regions 212c of the CF substrate 212 may be formed only in the vicinity of the intersections of the C-chamfered portions and the sides. When a notch is formed in the liquid crystal panel 102, the main surface 212a of the CF substrate 212 also has four non-disposition regions formed along the fifth corner 145, the sixth corner 146, the seventh corner 147, and the eighth corner 148 formed by the notch 102a.

### Planar Shape of Alignment Film

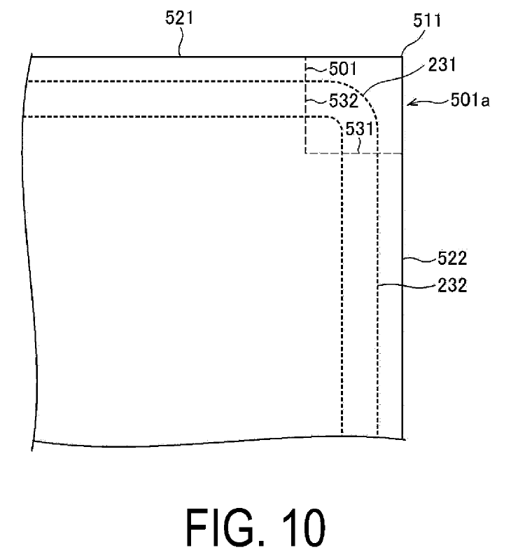

FIG. 10 is a plan view schematically illustrating a liquid crystal cell provided in the liquid crystal display device according to the first embodiment.

As illustrated in FIG. 10, a notch 501a is formed in each of alignment films 501 of the alignment film 307 of the TFT substrate 211 and the alignment film 405 of the CF substrate 212. The notch 501a is formed along each of corners 511 of the first corner 141, the second corner 142, the third corner 143, and the fourth corner 144. The notch 501a has a square planar shape or a rectangular planar shape. The square planar shape or the rectangular planar shape is surrounded by two sides 521 and 522 connected to each other at each corner 511 and two parallel lines 531 and 532 that are parallel to the two sides 521 and 522, respectively. As long as each alignment film 501 does not overlap the first portion 231, the notch 501a may have a planar shape other than a square planar shape and a rectangular planar shape.

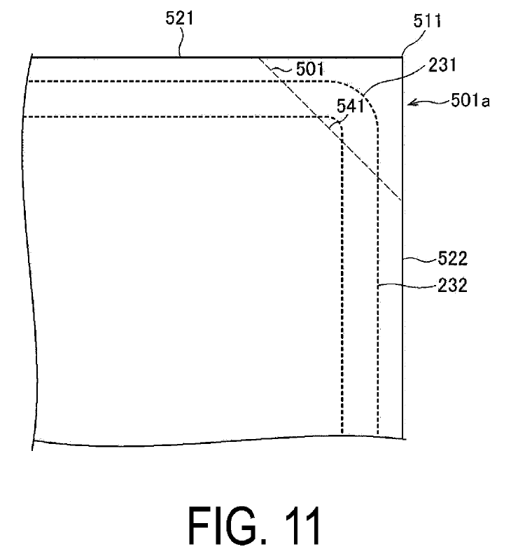

FIG. 11 is a plan view schematically illustrating a liquid crystal cell provided in a liquid crystal display device according to a sixth modification example of the first embodiment.

In the sixth modification example of the first embodiment, as illustrated in FIG. 11, the notch 501a has a triangular planar shape. The triangular planar shape is surrounded by one inclined line 541 inclined with respect to the two sides 521 and 522 and the two sides 521 and 522.

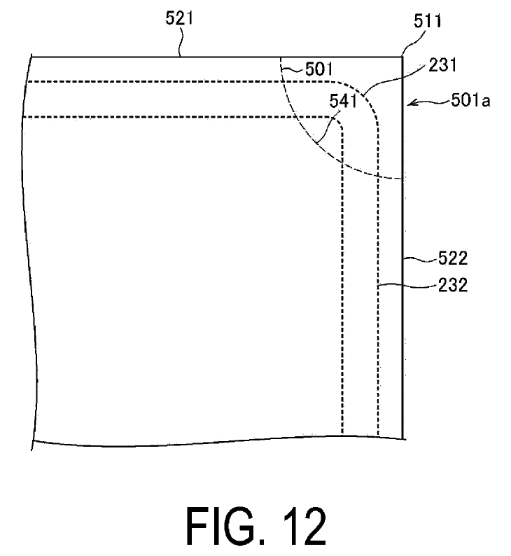

FIG. 12 is a plan view schematically illustrating a liquid crystal cell provided in a liquid crystal display device according to a seventh modification example of the first embodiment.

In the seventh modification example of the first embodiment, as illustrated in FIG. 12, a notch 501a has a planar shape surrounded by an arc line 541 and two sides 521 and 522.

### Second Embodiment

Hereinafter, differences of a second embodiment from the first embodiment will be described. For points that are not described, a configuration similar to the configuration employed in the first embodiment is also employed in the second embodiment.

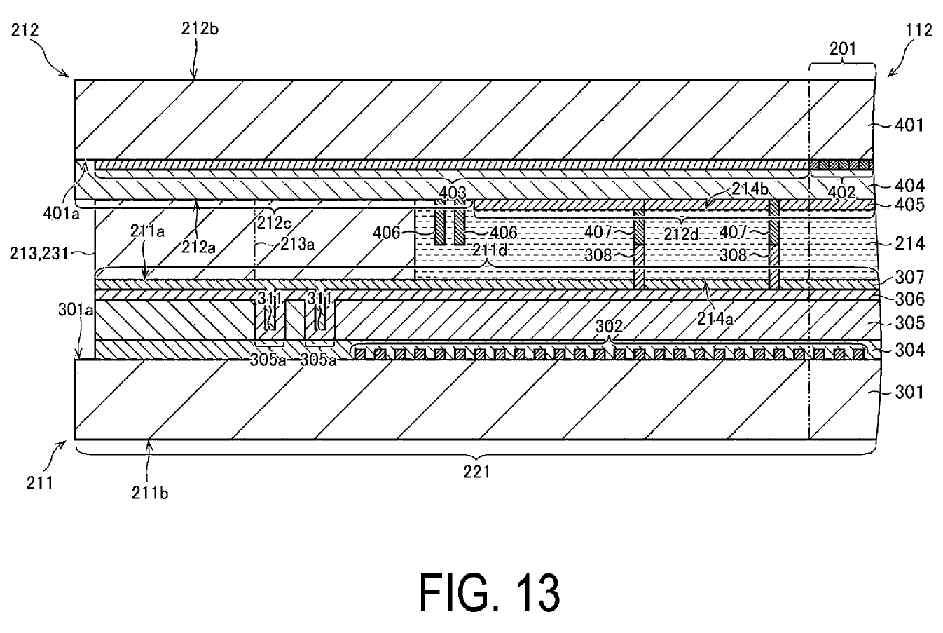

FIG. 13 is a cross-sectional view schematically illustrating a liquid crystal cell provided in a liquid crystal display device according to the second embodiment.

In the second embodiment, a notch is not formed in the alignment film 307 of the TFT substrate 211, but a notch is formed in the alignment film 405 of the CF substrate 212.

Therefore, as illustrated in FIG. 13, the entire first portion 231 is disposed on the disposition region 211d of the TFT substrate 211. Therefore, the entire interface between the first portion 231 and the TFT substrate 211 is formed in the disposition regions 211d. Therefore, the first portion 231 is not in contact with the passivation film 306 but is in direct contact with the alignment film 307 and is connected to the alignment film 307.

Also, the entire first portion 231 is disposed on the non-disposition region 212c of the CF substrate 212. Therefore, the entire interface between the first portion 231 and the CF substrate 212 is formed in the non-disposition region 212c. Therefore, the first portion 231 is not in contact with the alignment film 405 but is in direct contact with the overcoat 404 and is connected to the overcoat 404.

Even when a notch is formed only in the alignment film 405 of the CF substrate 212 in this manner, it is possible to prevent the first portion 231 from peeling off from the CF substrate 212 while maintaining a uniform in-plane distribution of chromaticity of the liquid crystal display device 1.

The second embodiment discloses an example in which a notch is formed in the alignment film of one of the two substrates of the liquid crystal panel 102. Of the two substrates, the first substrate having an alignment film in which a notch is formed is the CF substrate 212. Of the two substrates, the second substrate having an alignment film in which no notch is formed is the TFT substrate 211.

### Third Embodiment

Hereinafter, differences of a third embodiment from the first embodiment will be described. For points that are not described, a configuration similar to the configuration employed in the first embodiment is also employed in the third embodiment.

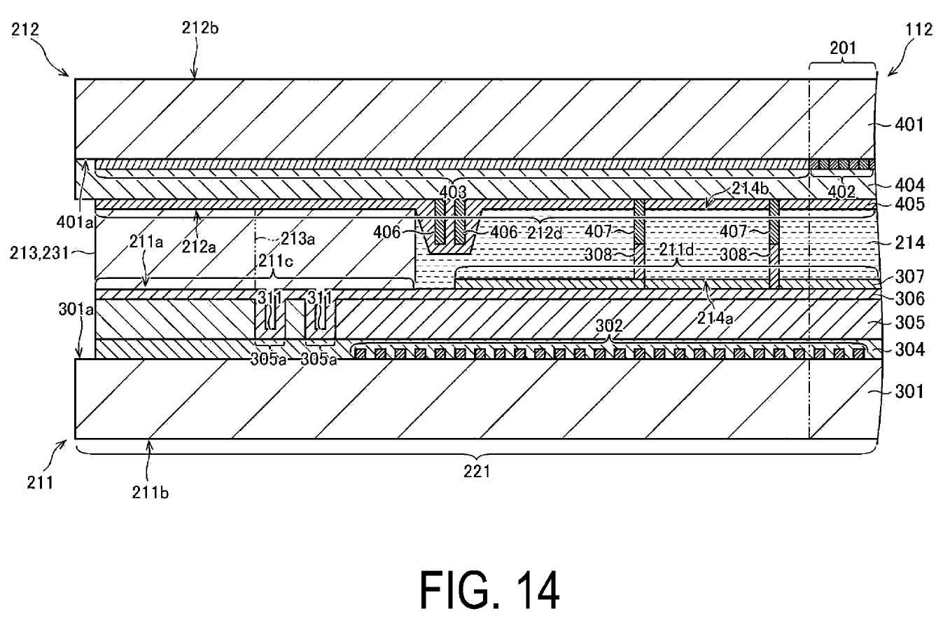

FIG. 14 is a cross-sectional view schematically illustrating a liquid crystal cell provided in a liquid crystal display device according to the third embodiment.

In the third embodiment, a notch is formed in the alignment film 307 of the TFT substrate 211, but a notch is not formed in the alignment film 405 of the CF substrate 212.

Therefore, as illustrated in FIG. 14, the entire first portion 231 is disposed on the non-disposition region 211c of the TFT substrate 211. Therefore, the entire interface between the first portion 231 and the TFT substrate 211 is formed in the non-disposition regions 211c. Therefore, the first portion 231 is not in contact with the alignment film 307 but is in direct contact with the passivation film 306 and is connected to the passivation film 306.

Also, the entire first portion 231 is disposed on the disposition region 212d of the CF substrate 212. Therefore, the entire interface between the first portion 231 and the CF substrate 212 is formed in the disposition region 212d. Therefore, the first portion 231 is not in contact with the overcoat 404 but is in direct contact with the alignment film 405 and is connected to the alignment film 405.

Even when a notch is formed only in the alignment film 307 of the TFT substrate 211 in this manner, it is possible to prevent the first portion 231 from peeling off from the TFT substrate 211 while maintaining a uniform in-plane distribution of chromaticity of the liquid crystal display device 1.

The third embodiment discloses an example in which a notch is formed in the alignment film of one of the two substrates of the liquid crystal panel 102. Of the two substrates, the first substrate having an alignment film in which a notch is formed is the TFT substrate 211. Of the two substrates, the second substrate having an alignment film in which no notch is formed is the CF substrate 212.

### Fourth Embodiment

Hereinafter, differences of a fourth embodiment from the first embodiment will be described. For points that are not described, a configuration similar to the configuration employed in the first embodiment is also employed in the fourth embodiment.

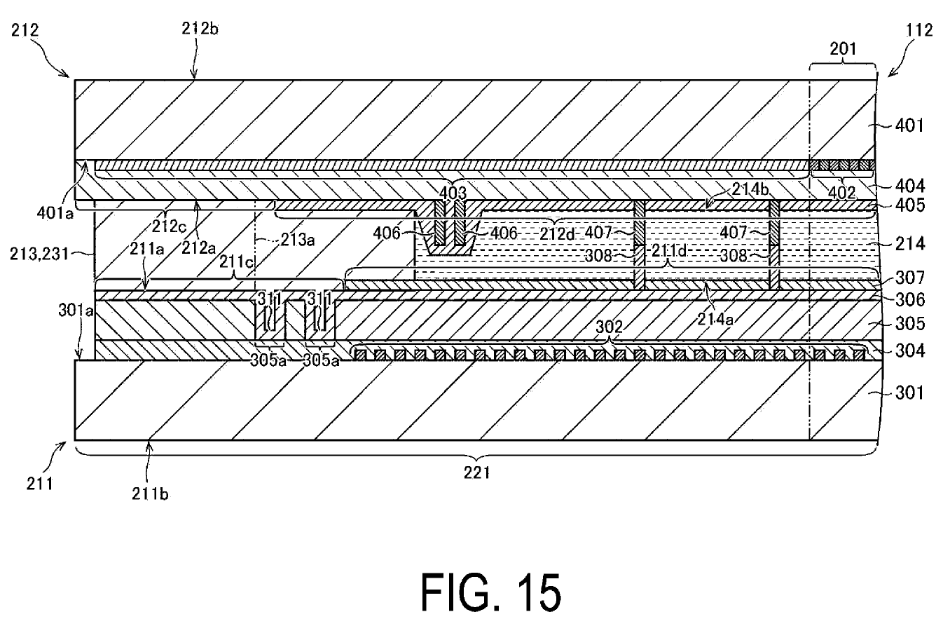

FIG. 15 is a cross-sectional view schematically illustrating a liquid crystal cell provided in a liquid crystal display device according to the fourth embodiment.

In the fourth embodiment, a notch formed in the alignment film 307 of the TFT substrate 211 and a notch formed in the alignment film 405 of the CF substrate 212 are smaller than those in the first embodiment.

Therefore, as illustrated in FIG. 15, the outer peripheral side of the first portion 231 is disposed on the non-disposition region 211c of the TFT substrate 211, but the inner peripheral side of the first portion 231 is disposed on the disposition region 211d of the TFT substrate 211. Therefore, the outer peripheral side of the interface between the first portion 231 and the TFT substrate 211 is formed in the non-disposition region 211c, but the inner peripheral side of the interface is formed in the disposition region 211d. Therefore, only a part of the interface is formed in the non-disposition region 211c. Therefore, the outer peripheral side of the first portion 231 is not in contact with the alignment film 307 but is in direct contact with the passivation film 306 and is connected to the passivation film 306, but the inner peripheral side of the first portion 231 is not in contact with the passivation film 306 but is in contact with the alignment film 307 and is connected to the alignment film 307.

Furthermore, the outer peripheral side of the first portion 231 is disposed on the non-disposition region 212c of the CF substrate 212, but the inner peripheral side of the first portion 231 is disposed on the disposition region 212d of the CF substrate 212. Therefore, the outer peripheral side of the interface between the first portion 231 and the CF substrate 212 is formed in the non-disposition region 212c, but the inner peripheral side of the interface is formed in the disposition region 212d. Therefore, only a part of the interface is formed in the non-disposition region 212c. Therefore, the outer peripheral side of the first portion 231 is not in contact with the alignment film 405 but is in direct contact with the overcoat 404 and is connected to the overcoat 404, but the inner peripheral side of the first portion 231 is not in contact with the overcoat 404 but is in direct contact with the alignment film 405 and is directly connected to the alignment film 405.

In this way, even when the notch formed in the alignment film 307 of the TFT substrate 211 and the notch formed in the alignment film 405 of the CF substrate 212 are smaller, it is possible to prevent the first portion 231 from peeling off from the TFT substrate 211 and the CF substrate 212 while maintaining a uniform in-plane distribution of chromaticity of the liquid crystal display device 1.

The disclosure is not limited to the embodiments described above, and may be substituted with a configuration that is substantially the same as the configuration described in the embodiments described above, a configuration that achieves the same action and effect, or a configuration capable of achieving the same object.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A liquid crystal panel including two sides adjacent to each other and a connection portion connecting the two sides to each other, the liquid crystal panel comprising:
a first substrate including a first alignment film and including a first main surface, the first main surface including a non-disposition region formed along the connection portion and in which the first alignment film is not disposed and a disposition region in which the first alignment film is disposed;
a second substrate including a second main surface;
a liquid crystal layer disposed between the first main surface and the second main surface; and
a seal disposed between the first main surface and the second main surface, surrounding the liquid crystal layer, and including a first portion disposed along the connection portion and a remaining second portion, at least a part of an interface between the first substrate and the first portion being formed in the non-disposition region, and an entire interface between the first substrate and the second portion being formed in the disposition region.

2. The liquid crystal panel according to claim 1,
wherein the non-disposition region is a first non-disposition region,
the disposition region is a first disposition region,
the second substrate includes a second alignment film,
the second main surface includes a second non-disposition region formed along the connection portion and in which the second alignment film is not disposed and a second disposition region in which the second alignment film is disposed,
at least a part of an interface between the first portion and the second substrate is formed in the second non-disposition region, and
an entire interface between the second portion and the second substrate is formed in the second disposition region.

3. The liquid crystal panel according to claim 1,
wherein the disposition region extends to an outer periphery of the first main surface.

4. The liquid crystal panel according to claim 1,
wherein the connection portion includes a corner, an R-chamfered portion, or a C-chamfered portion.

5. The liquid crystal panel according to claim 1,
wherein one of the first substrate and the second substrate includes an alignment film,
the one substrate includes a surface on which the alignment film is formed,
a groove having a ring-shaped planar shape is formed on the surface, and
the groove is formed in a region where the seal is disposed.

6. The liquid crystal panel according to claim 1,
wherein one of the first substrate and the second substrate includes an alignment film,
the one substrate includes a surface on which the alignment film is formed,
the one substrate includes a pattern having a ring-shaped planar shape and protruding from the surface, and
the pattern is disposed along an inner periphery of a region where the seal is disposed.
